(19) United States
(12) Patent Application Publication
(10) Pub. No.: US 2002/0065928 A1
(43) Pub. Date: May 30, 2002

(54) Multicast system capable of dividing entire group into plural groups with easier procedures

(75) Inventors: Satoshi Senga, Tokorozawa-shi (JP); Akino Inoue, Tokyo (JP); Masaki Satou, Urayasu-shi (JP); Toshio Oka, Yokohama (JP); Toshimasa Takaki, Tokyo (JP)

Correspondence Address: LOWE HAUPTMAN GILMAN & BERNER, LLP, Suite 310, 1700 Diagonal Road, Alexandria, VA, 22314, US

(73) Assignee: Matsushita Electric Industrial Co., Ltd.

(21) Appl. No.: 09/989,110

(22) Filed: Nov. 21, 2001

(30) Foreign Application Priority Data
Nov. 24, 2000 (JP) 2000-358459

(51) Int. Cl. G06F 15/16

(52) U.S. Cl. 709/231; 709/206

(57) ABSTRACT

A conference terminal is incorporated in a multicast conferencing system. The conference terminal receives a request for division into groups. The request includes information indicating that the terminal belongs to which group. The terminal then produces, in response to the request, only the stream data coming from one or more other conference terminals belonging to the same group as the terminal. This production is realized by selectively accepting such stream data at a reception unit to which all stream data are transmitted from all the terminals having the same multicast address. Alternatively, the production is realized by selectively re-writing stream data at a scene re-writer. Thus, the produced stream data are replayed and displayed. The division of an entire group into plural small groups can be performed without additionally issuing multicast addresses.

### BACKGROUND OF THE INVENTION

1. Field of the Invention

The present invention relates to a multicast system in which a plurality of terminals are distributed and connected via a network so that data can be transmitted in a multicast mode in the system. By way of example, the present invention is realized a multicast conferencing system that has such construction and is capable of dividing an entire multicast conference group into a plurality of multicast conference groups with easier procedures.

2. Related Art

There has been higher demands for television conference systems that allows people who are present at long distant places from each other to perform a meeting, gathering, conference, convention, or others (i.e., “conference”). A multicast conferencing system is one example of such systems.

One conventional system for a multicast conference is shown in FIG. 1, in which a plurality of conferencing terminals 2001-a to 2001-d are connected to each other via a communication network 2000. The communication network 2000 is for example a local area network system represented by IEEE802.3, wherein a variety of computers including servers, workstations, and personal computers are communicably connected with each other.

In this communication network 2000, by way of example, the conferencing terminal 2001-a directly sends stream data consisting of videos and audios to other conferencing terminals 2000-b, 2000-c, and 2000-d having the same group address in a multicast mode. The group address, which is a sub address, shows that all terminals having the group address belong to the same group for a multicast conference. Thus, each of the conferencing terminals 2000-b, 2000-c, and 2000-d is able to receive the same stream data from the conferencing terminal 2000-a. This way permits each conferencing terminal 2000-a (to 2000-d) to receive stream data from all the conferencing terminals that have participated in the conference, so that the conference can be held through the network.

In such a multicast conference, it is frequently assumed that the participants having the same group address be divided into several groups and a multicast conference is held group by group within the members belonging to the same group. This division into groups can be seen very often in learning linguistics, for example. In most cases, linguistic learning involves an instructor who teaches plural learners, and in lessons, there are scenes that the instructor changes groups in which learners talk to each other within the members of each group. In this way, learning linguistics requires that the groups be changed frequently.

The division of an entire group into small groups (subgroups) in a conventional conferencing system will now be exemplified with reference to FIG. 2.

In the example shown in FIG. 2, the conference terminals 2000-a to 2000-d use the same group address “A” to hold the entire conference “A.” It is often desired that the entire conference “A” be divided into two small groups: one group conference “B” to which the conference terminals 2000-a and 2000-b attend and the other group conference “C” to which the conference terminals 2000c and 2000d attend. To realize such demand, new group addresses “B” and “C” should be assigned to the respective conference terminals, apart from the entire group address “A.” That is, the group addresses equal in number to the groups to be divided should be prepared, before the enter conference group is divided into plural small groups.

However, the division of an entire multicast conference according to the above conventional technique faces some drawbacks. One is caused when the participants having the same group address are divided into several small groups. In this case, the participants' procedures are forced to increase, because new group addresses should be additionally assigned to the respective conference terminals. Such additional group addresses are “B” and “C” in the above example, which are different from the entire address “A.” In other words, the number of group addresses increases in proportion to that of groups to be divided. Additionally, the more the number of groups to be divided, the more complicated the management of their group addresses.

The above procedures imposed on the participants will now be detailed with reference to FIGS. 2 and 3. In this description, suppose that a host user's conference terminal (i.e., host conference terminal) is assigned to a terminal 2000-a and one participant's terminal (i.e., one client terminal) is a terminal 2000-b, that is, a representative of all the terminals 2000-b to 2000-d.

Under the open of an entire conference “A” to which the terminals 2000-a to 2000-d attend, the host conference terminal 2000-a issues a request for dividing the conference into several small groups. In this case, first, the host of the conference decides members who compose each group, then assigns group addresses to the client terminals (that is, the resources are assigned). It is required that the group addresses be prepared for by the number of divided groups. Then, the host terminal 2000-a sends to the client conference terminal 2000-b a request for disconnecting the entire conference “A.” Responsively to this, the client conference terminal 2000-b performs processing to terminate the entire conference “A” to disconnect it. The disconnection from the entire conference “A” is also carried out at the host conference terminal 2000-a.

After the disconnection, the client conference terminal 2000-b notifies the host conference terminal 2000-a of the completion of disconnection from the entire conference “A.”

The host conference terminal 2000-a then sends to the client conference terminal 2000-b a request for connection to a new group “B” to be divided. When receiving a request for holding a group conference “B,” the client terminal 2000-b sets initial conditions for the group conference “B.” This initial setting includes initialization of a communication interface to receive a new group address “B” and setting to receive various pieces of information such as videos and audios. The later setting is similar to the setting carried out at each terminal combined into an ordinal television conference system. The above initial setting is also carried out at the host client terminal 2000-a.

Then, at each terminal, a layout for displaying all the participants (members) belonging to the new group “B” is selected, before the group conference “B” is actually held.

As sated above, the group division in the conventional multicast conference requires many complicated procedures necessary for the disconnection and connection, which are all imposed on the participants, as well as large numbers of group addresses required in number correspondingly to the groups. This problem becomes serious particularly in cases where divisions into groups and/or changeovers of entire groups are so often during one time of conferencing, like linguistic learning.

### SUMMARY OF THE INVENTION

The present invention has been made with due consideration to the drawbacks of such a conventional multicast conferencing technique. A first object of the present invention is to provide a multicast conferencing system that enables the conference terminals to divide an entire multicast conference to be divided into plural groups or to change groups in the multicast conference with easier operations, without changing their group addresses which have been used at present (that is, with the same group address kept) when a request for division into groups is issued.

A second object of the present invention is to provide a multicast conferencing system in which the group addresses that have been used at present can be assigned to the terminals, independently of the number of divided groups and without management of the addresses.

In order to realize the above objects, as one aspect of the present invention, there is provided a method of controlling processing of stream data communicated in a multicast mode, the processing being conducted by a certain terminal of a plurality of terminals having the same multicast address, the method comprising the steps of: receiving a request for division into groups, the request indicating which one or more other terminals belong to the same group; and performing either one of selective reception and selective replay of stream data issued from only the one or more other terminals belonging to the same group in accordance with the request, the stream data being simultaneously transmitted through a communication network to the plurality of terminals having the same multicast address.

As another aspect of the present invention, there is provided a terminal distributed, together with other terminals to form a plurality of terminals to which the same multicast address is given, through a communication network in a multicast system in which stream data are transmitted through the communication network in a multicast mode, the terminal comprising: request receiving means for receiving a request for division into groups, the request including information indicating that the terminal belongs to which group; producing means for producing, in response to the request, only the stream data coming from one or more other terminals belonging to the same group as the terminal; and replaying means for replaying only the stream data produced by the producing means.

Preferably, the multicast system is a multicast conferencing system for a multicast conference, in which the terminal serves as one of a plurality of conference terminals.

In this configuration, as a first example, it is preferred that the producing means includes: data receiving means for selectively receiving only the stream data coming from the one or more other terminals indicated by the request among the stream data coming from the other conference terminals having the same multicast address; and scene re-writing means for re-writing the stream data selectively received into a scene description on the basis of scene descriptions making correspondence between layout information to be displayed and the stream data, and the replaying means is configured to replay the stream data according to both of the stream data selectively received by the receiving means and the scene description re-written by the scene re-writing means.

In this first example, the data receiving means selectively receives only stream data coming from the one or more other terminals of each divided group. Therefore, in a multicast conference, it is possible to receive and transmit stream data only among the members of the same group, with no additional issue of multicast addresses.

It is also preferred, as a second example, that the producing means includes: data receiving means for receiving the stream data from the other conference terminals having the same multicast address; and scene re-writing means for selectively re-writing only the stream data into a scene description on the basis of scene descriptions making correspondence between layout information to be displayed and the stream data, the stream data to be re-written coming from the one or more other terminals indicated by the request among the stream data coming from the other conference terminals having the same multicast address, and the replaying means is configured to selectively replay the stream data received by the receiving means in accordance with the scene description re-written by the scene re-writing means.

In this second example, the scene re-writing means selectively re-writes, into a scene description on the basis of scene descriptions, only the stream data coming from the one or more other terminals of each divided group. In a multicast conference, it is therefore possible to replay stream data transmitted from the members of the same group. Accordingly, stream data can be received and transmitted in a multicast mode, group by group, among the members of each divided group, with no additional issue of multicast addresses.

Still preferably, the multicast conferencing system further comprises deciding means for arbitrarily deciding a plurality of divided groups of terminals among the plurality of terminals all having the same multicast address; and issuing means for issuing the request, based on the plurality of groups decided, to the request receiving means and the other terminals all having the same multicast address.

In this multicast conferencing system, as a third example, it is preferred that the producing means includes: data receiving means for selectively receiving only the stream data coming from the one or more other terminals indicated by the request among the stream data coming from the other conference terminals having the same multicast address; and scene rewriting means for re-writing the stream data selectively received into a scene description on the basis of scene descriptions making correspondence between layout information to be displayed and the stream data, and the replaying means is configured to replay the stream data according to both of the stream data selectively received by the receiving means and the scene description re-written by the scene re-writing means.

In this third example, the selective reception of stream data coming from the one or more conference terminals of each divided group is performed in response to the request from the issuing means. In a multicast conference, it is therefore possible to receive and transmit stream data only among the members of the same group, with no additional issue of multicast addresses. This conference terminal capable of issuing the command can be used as a terminal for a host or chairperson of a multi conference.

Still it is preferred, as a fourth example, that the producing means includes: data receiving means for receiving the stream data from the other conference terminals having the same multicast address; and scene re-writing means for selectively re-writing only the stream into a scene description on the basis of scene descriptions making correspondence between layout information to be displayed and the stream data, the data to be re-written coming from the one or more other terminals indicated by the request among the stream data coming from the other conference terminals having the same multicast address, and the replaying means is configured to selectively replay the stream data received by the receiving means in accordance with the scene description re-written by the scene re-writing means.

In this fourth example, the selective re-writing of stream data coming from the one or more conference terminals of each divided group is performed in response to the request from the issuing means, with no additional issue of multicast addresses. This conference terminal capable of issuing the command can be used as a terminal for a host or chairperson of a multi conference as well.

The other constructions, features, and/or advantages of the present invention will be understood from the description in the following embodiments and appended drawings.

### BRIEF DESCRIPTION OF THE DRAWINGS

In the accompanying drawings:

FIG. 1 illustrates connections in a conventional multicast conference;

FIG. 2 shows the division of an entire multicast conference into a plurality of small group conferences according to a conventional technique;

FIG. 3 is a conventional sequence showing the group division carried out between terminals operated a host and a participant;

FIG. 4 shows a basis concept in dividing an entire multicast conference into a plurality of small group conferences according to first to fourth embodiments of the present invention;

FIG. 5 is a block diagram schematically showing a conference terminal adopted by the first embodiment of the present invention;

FIG. 6 illustrates in detail selective reception and acceptance of stream data in the first embodiment;

FIG. 7 is a sequence showing a group division carried out between terminals operated a host and a participant;

FIGS. 8A and 8B exemplify the screens of the display device on which stream data are replayed in each window in individual layouts corresponding to the group division;

FIG. 9 illustrates the configuration of a scene description database in the first to fourth embodiments;

FIG. 10 is a block diagram of a computer system showing a modification of the conference terminal according to the first embodiment;

FIG. 11 is a flowchart outlining the processing executed by a CPU incorporated in the computer system shown in FIG. 10;

FIG. 12 is a block diagram schematically showing a conference terminal adopted by the second embodiment of the present invention;

FIG. 13 illustrates in detail selective reception replay and display of stream data in the second embodiment;

FIG. 14 is a block diagram schematically showing a conference terminal adopted by the third embodiment of the present invention;

FIG. 15 shows the configuration of an example of a request for division into groups, which is issued from the conference terminal according to the third and fourth embodiments;

FIG. 16 shows the configuration of another example of a request for division into groups, which is issued from the conference terminal according to the third and fourth embodiments;

FIG. 17 illustrates in detail selective reception and acceptance of stream data in the third embodiment;

FIG. 18 is a flowchart outlining the processing executed by a CPU incorporated in a computer system incorporated in a conference terminal of a modification according to the third embodiment;

FIG. 19 is a block diagram schematically showing a conference terminal adopted by the fourth embodiment of the present invention; and

FIG. 20 illustrates in detail selective reception replay and display of stream data in the fourth embodiment.

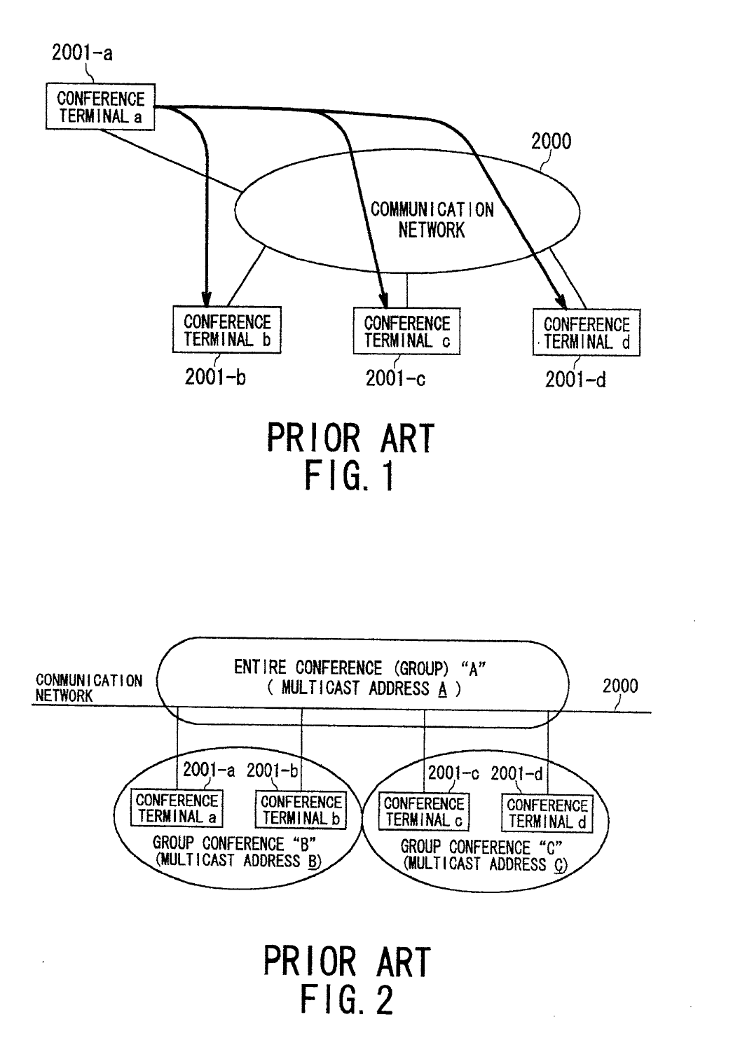

### PREFERRED EMBODIMENTS OF THE INVENTION

With reference to the accompanying drawings, preferred embodiments of the present invention will now be described.

(First Embodiment)

Referring to FIGS. 4 to 9, a first embodiment of the present invention will now be described.

FIG. 4 exemplifies the entire configuration of a multicast conferencing system according to a first embodiment of the present invention.

In the present embodiment, a group address is used as sub-address information that indicates conference terminals belonging to the same divided group. When it is required that the participants be divided into groups in all participants of which group address is the same, a common group address that all the participants have used before a group division is continuously used in each divided group. In each of the newly divided groups, only the participants belonging to each group are able to continue a multicast conference.

A difference from the conventional system is that, in cases where the participants of which group addresses are the same are divided into plural groups, there is no need for assigning new group addresses to the conference terminals, while still enabling the group division. The group address that the participants have used in common prior to the group division can sill be used.

In FIG. 4, the multicast conferencing system includes a plurality of conference terminals 100-1 to 100-5 communicably connected to each other through a communication network 1000. The communication network 1000 is for example a local area network system represented by IEEE802.3, wherein a variety of computers including servers, workstations, and personal computers are communicably contend with each other.

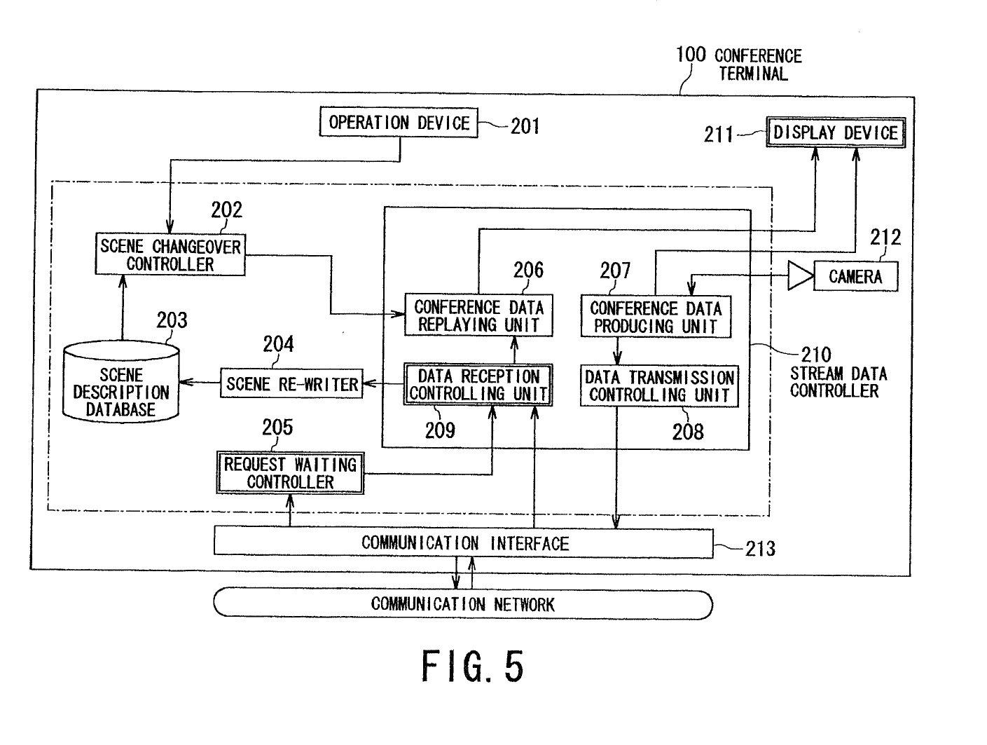

FIG. 5 details the configuration of each terminal 100 used for a multicast conference. Each terminal 100 includes an operation device 201, scene changeover controller 202, scene description database 203, scene re-writer 204, request waiting controller 205, stream data controller 210, display device 211, and communication interface 213.

The operation device 201 has one or more devices chosen from a mouse and a keyboard so as to receive inputs from a user. The display device 211 is used for display images of a conference. The communication interface 213 is responsible for transmission and reception of data to and from the communication network 1000.

The stream data controller 210 includes a conference data generating unit 207, data transmission controlling unit 208, data reception controlling unit 209, and conference data replaying unit 206. Of these, the conference data producing unit 207 produces images inputted from the camera 212 as stream data. The produced stream data are transmitted to other participants' conference terminals by the data transmission controlling unit 208. The data reception controlling unit 209 is placed to receive stream data that have been transmitted from other participants' conference terminals. The conference data replaying unit 206 is responsible for replay control of the stream data.

The foregoing scene changeover controller 202 sends a scene changeover control signal to the conference data replay unit 206 in response to a command from the operation device 201. This scene changeover controller 202 also receives information about a scene description composed of conference layout information consisting of a size and a position of each window to display and replay video data and conference media information consisting of identification information about stream data to be replayed, and sends it to the conference data replaying unit 206. The scene description information is also sent to the display apparatus 211 in order to change over display modes of windows displayed on the screen thereof.

In the present embodiment, an operation of the conference terminal 100-3 is detailed representatively to show that the request waiting controller 205, data reception controlling unit 209, and scene rewriter 204 are essential parts for accomplishing the function of dividing an entire conference into plural small groups.

The data reception controlling unit 209 receives stream data that have been supplied from other conference terminals in a multicast conference. The request waiting controller 205 waits for a notification of a request for division into groups, which is issued by a host conference terminal participating in the conference. When receiving such division request, the request waiting controller 205 notifies the data reception controlling unit 209 of stream data which should be sent out through the self conference terminal 100-3 in response to the division into groups.

The data reception controlling unit 209, which received such notification from the request waiting controller 205, is able to select and pass stream data directed to the same group through the unit 209. This makes it possible to pass only stream data directed to each group divided from an entire conference.

The scene re-writer 204 rewrites the stream data selected by the data reception controlling unit 209 into data of a scene description in a reflection manner, thus providing a scene description that corresponds to the division into groups.

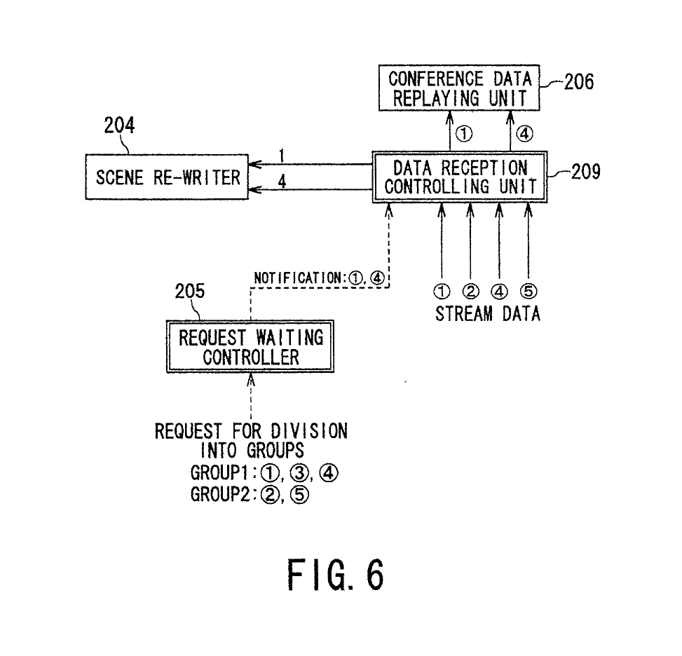

FIG. 6 exemplifies the operation for displaying stream data, in which conference terminals that participate in a multicast conference are 100-1 to 100-5, the host conference terminal capable of issuing a request for division into groups is assigned to a terminal 100-1, and a conference terminal 100-3 selects stream data to be received according to the division request and display stream data from only the same group's members (i.e., conference terminals).

Before receiving the division request, the terminal 100-3 is able to receive stream data from all of the other conference terminals participating in the multicast conference thanks to its data reception controlling unit 209. Such stream data are 1, 2, 4 and 5.

If the host conference terminal 100-1 issues a request for dividing the current entire group into some small groups, the request waiting controller 205 in the client conference terminal 100-3 receives the request. As a result, the request waiting controller 205 recognizes that the client conference terminal 100-3 itself is divided, together with other two terminals 100-1 and 100-4, from the entire conference group, so the conference terminals 100-3, -1, and -4 constitute the same divided group 1. The request waiting controller 205 therefore notifies the data reception controlling unit 209 of selecting and passing stream data 1 and 4 received from the terminals 100-1 and 100-4 through the unit 209, respectively. Responsively to this notification, the data reception controlling unit 209 prevents stream data 2 and 5 from passing this unit 209, thus discarding the stream data 2 and 5, and passing only stream data 1 and 4 to the conference data replaying unit 206. In addition, the unit 209 sends to the scene rewriter 204 the identification numbers of senders who originates only the stream data 1 and 4.

As stated, the operation performed by the data reception controlling unit 209 allows stream data of only the grouped members to pass therethrough after the group division. This makes it possible to divide the entire group into plural small groups (subgroups) in the multicast conference, with the group address unchanged.

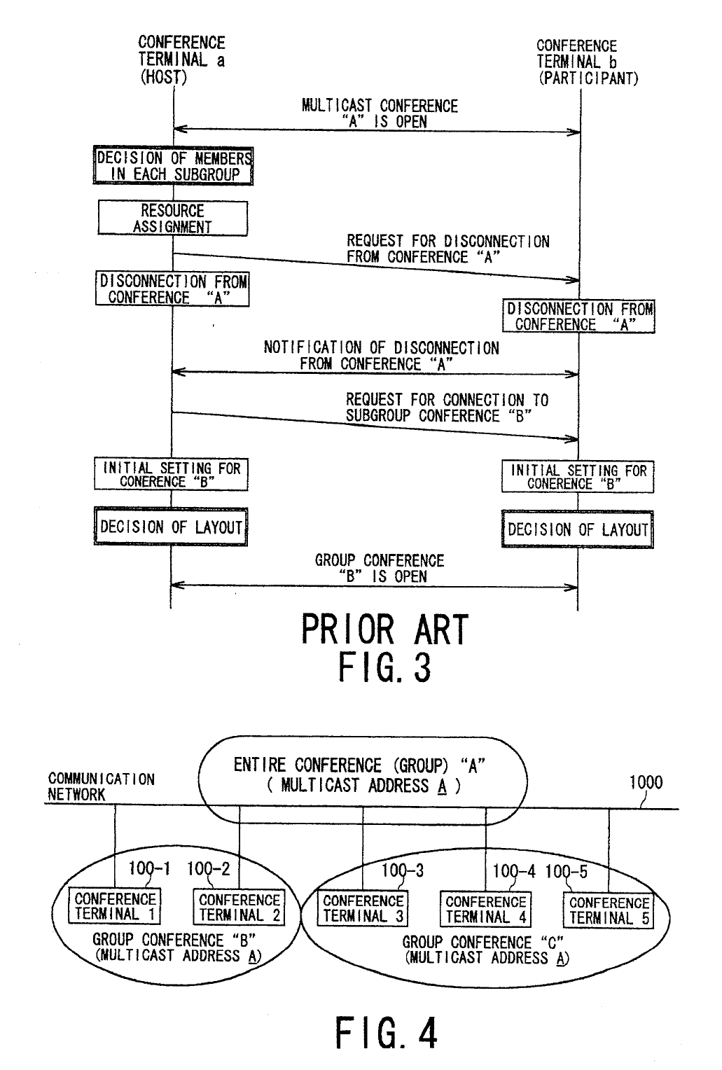

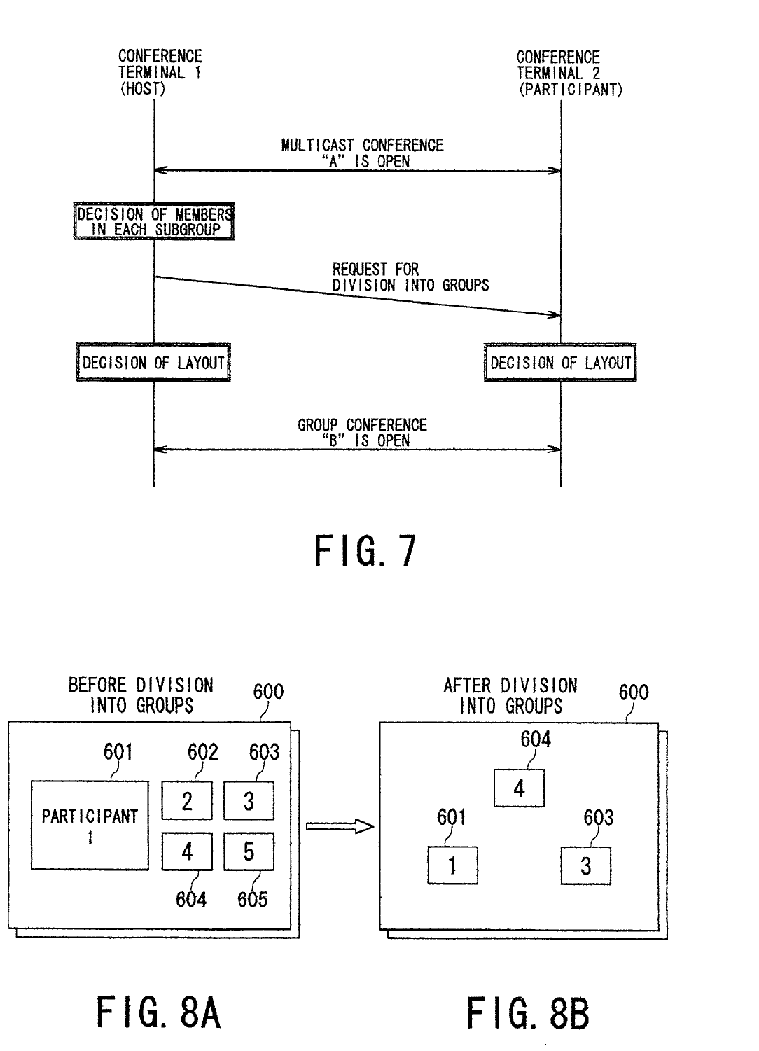

FIG. 7 shows a sequence carried out between the host conference terminal 1 (100-1) operated by the host of a multicast conference and one client conference terminal 2 (100-2) operated by a participant in the conference. This flow is provided in comparison with that shown in FIG. 3. When an entire conference “A” is open, the host conference terminal 1 decides a division of the entire conference group, according to its necessity.

First the host conference terminal 100-1 decides the number of small groups and each member who belongs to each group. Then the terminal 100-1 issues a request for division into groups toward all the client conference terminals addressed by the same multicast address so far.

The client conference terminal 100-2 (and the remaining other terminals) that has received the request responds to select and accept stream data coming from only the members of the same group. Then the terminal 100-2 (and the other terminals) decides a layout of stream data to be displayed on the display device 211 in accordance with the number of new members of each group. As a result, each client terminal is able to continually participate in a multicast conference “B” carried out among the new members. In this group division, issuing additional multicast addressees is unnecessary, and the procedures for the division are greatly simplified.

FIGS. 8A and 8B exemplify a screen 600 displayed on the display device 211 before and after the entire group is divided, respectively. Before such division, all windows 601 to 605 for all the participants 1 to 5 who operate the conference terminals 100-1 to 100-5 are displayed on the screen 600 of each terminal so that images of the participants in a multicast conference are present thereon (refer to FIG. 8A). In contrast, the screen 600 is updated as shown in FIG. 8B after the division, on which windows are reduced in number to represent only the members belonging to the same divided group (refer to FIG. 8B). In the case of FIG. 8B, only the three windows 601, 603 and 604 are present to show images of participants who operate the conference terminals 100-1, 100-3 and 100-4.

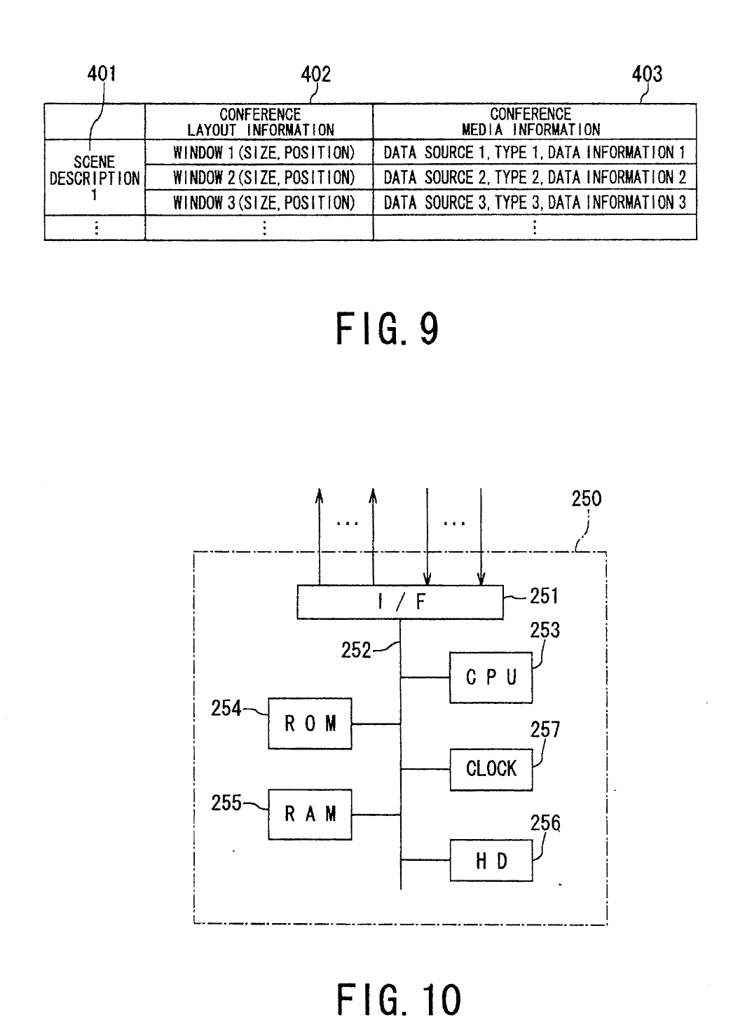

FIG. 9 illustrates a format of data base information stored in the scene description data base 203 used in producing information about scene descriptions. A scene description 401 is composed of conference layout information 402 and conference media information 403. The conference layout information 402, which is pieces of window information used for displaying and replaying video data in order to represent a participants' images on the display device 211, describes a displayed size and a displayed position of each window. The conference media information 403, which is information in relation to an image of a participant in a multicast conference, describes information, such as a data source to inform the position of a data sender, which is composed of a multicast address, port number, and sender's identification number; the type of media data to distinguish, for example, movies from still pictures; and a bit rate of data to be transmitted.

In replaying of stream data, by way of example, only the layout information is changed over in response to the re-written scene description so that only stream data coming from one or more other terminals belonging to the same group are replayed. Alternatively, only the media information may be changed over in response to the re-written scene description so that only stream data coming from one or more other terminals belonging to the same group are replayed.

The changeover of display layouts will now be explained. The conference media information 403 in the scene description database 203, which stores therein the foregoing scene descriptions, is rewritten into information indicated by stream data, thus an updated scene description being produced. This new scene description is used to change over display modes of windows presented on the display device 211.

As stated above, selecting stream data which should be adopted enables the same group in a multicast conference can be divided into a plurality of small groups (subgroups) in a wide range of divided group modes, with no changes in the group address that has been originally given to the conference terminals constituting the entire group. This facilitates the procedures required for dividing an entire group in a multicast conference and enhances flexibility in making the conference progress. This way of division is particularly effective in educational lessens, such as linguistic programs, such that an instructor divides the whole learners into several subgroups to let them talk with each other within each subgroup in lessens.

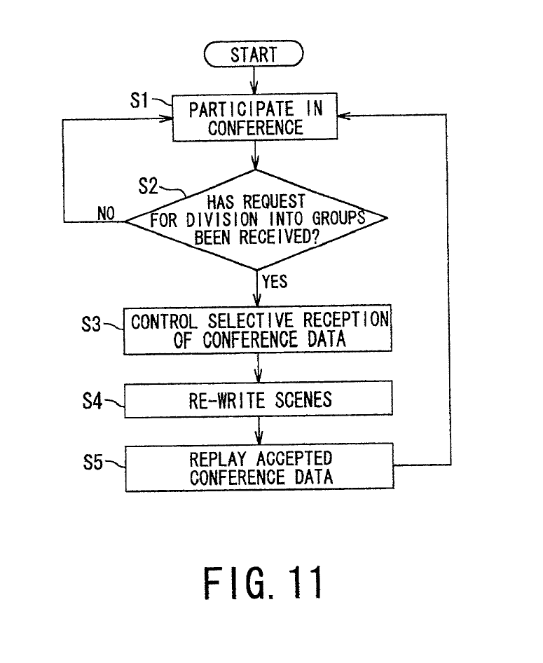

FIGS. 10 and 11 show one modification of the first embodiment according to a multicast conferencing system of the present invention. In the first embodiment, each conference terminal 100 is explained to have, as hardware circuitry, the stream data controller 210, scene changeover controller 202, scene description database 203, scene re-writer 204, and request waiting controller 205. However, those units 210, 202 to 205 can be replaced by a computer system 250 schematically exemplified in FIG. 10.

The computer system 250 shown in FIG. 10 includes an interface 251 to which a bus 252 is coupled. In this computer system 250, the constituents connected to the bus 252 include a CPU (central processing unit) 253, ROM 254, RAM 255, hard disk drive 256, and clock 257. Of these, the interface 250 is capable of communicating with external systems, such as the operation device 201, display device 211, camera 212, and communication interface 213, which are placed outside the computer system 250. The CPU 253 is able to perform various types of processing required for participating in a multicast conference, based on programs previously stored in the ROM 254. In consequence, the ROM 254 constitutes a recording medium in which programs according to the present invention are stored. The RAM 255 and hard disk memory 256 are used as data storage units.

FIG. 11 outlines the processing performed by the CPU 253 in each client conference terminal in order to coop with a request for division into groups. In cases where the CPU 253 is under participation in a multicast conference (step S1), the CPU 253 determines at intervals whether or not it receives a request for division into groups (step S2). If this determined result is NO (such request has yet to receive), the processing is returned to step S1, while the determined result is YES (the request has been received), the CPU 253 controls the selective data reception that has been explained in the first embodiment (step S3).

Then, the CPU 253 performs re-writing scenes (step S4), before it replays conference data that has been accepted (step S5), both in such manners similar to those in the first embodiment.

Accordingly, each conference terminal that contains the computer system 250 performing a software program outlined in FIG. 11 functions identically to the constituents shown in FIG. 6.

(Second Embodiment)

Referring to FIGS. 5, 12 and 13, a second embodiment of the present invention will now be described. Incidentally, in the second embodiment, the identical or similar constituents to those in the first embodiment use the same reference numerals, so their explanations are omitted or simplified for avoiding redundancy in description. This way of description will be applied to third and fourth embodiments, which will be described later.

The second embodiment provides a further construction of a conference terminal dedicated to a multicast conference.

FIG. 5 also exemplifies the entire configuration of a multicast conferencing system according to the second embodiment. In this embodiment, the client conference terminal 100-2 will now be detailed as a representative as follows.

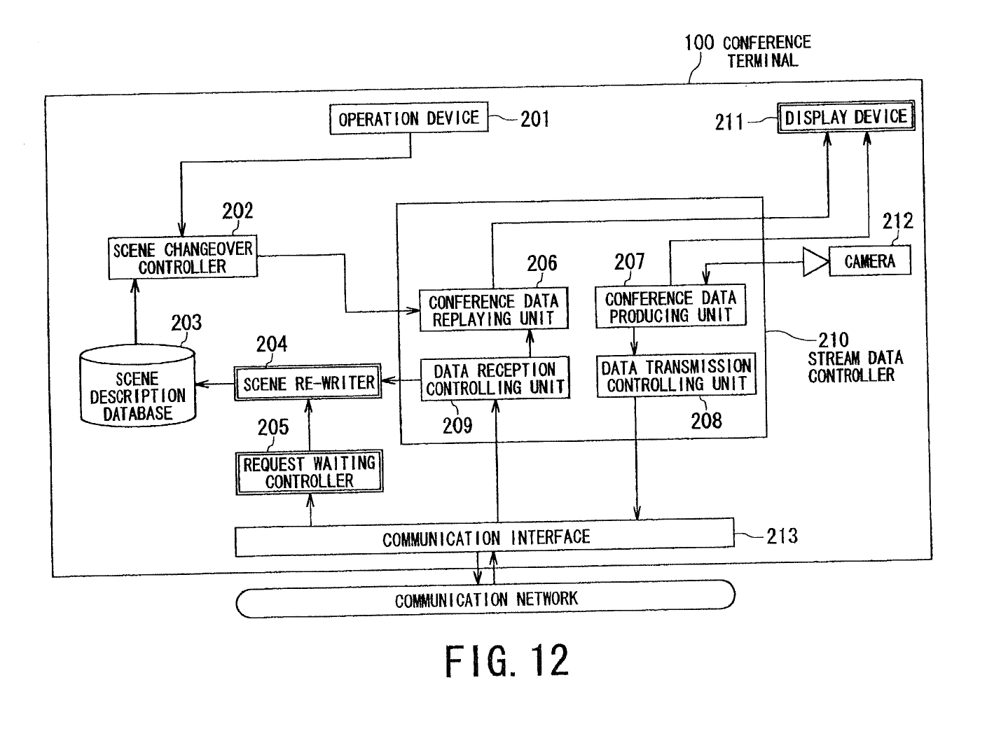

FIG. 12 details the configuration of the terminal 100-2 shown in FIG. 5. In FIG. 12, the explanation will now be concentrated on the operations of the constituents, such as the request waiting controller 205, scene re-writer 204, and data reception controlling unit 209. The remaining constituents of the conference terminal 100-2 are almost identical to those in the first embodiment.

The data reception controlling unit 209 is configured to receive stream data coming from all the terminals that participate in a certain multicast conference. The scene re-writer 204 re-writes scene descriptions, which make correspondence between information about layouts for display and stream data from each terminal, in response to the stream data the data reception controlling unit 209 has received.

The request waiting controller 205 waits for a request for division into groups, which will be issued from a certain conference terminal that participates in a multicast conference. In cases such request is received, the request waiting controller 205 notifies the scene re-writer 204 of stream data which should be reflected and re-written into scene descriptions in this conference terminal 100-2. Such stream data that require re-writing into the scene descriptions are data coming from conference terminals of the same group as the conference terminal 100-2.

Responsively to the notification from the request waiting controller 205, the scene re-writer 204 is then able to select only the stream data that have been transmitted from the terminals belonging to the same group, and reflects and rewrites the selected stream data into the scene descriptions.

As stated above, the scene descriptions are produced according to the division of a multicast entire conference into plural small groups. Accordingly, the stream data from only the members (conference terminals) belonging to the same divided group can be replayed and displayed on the display device 211.

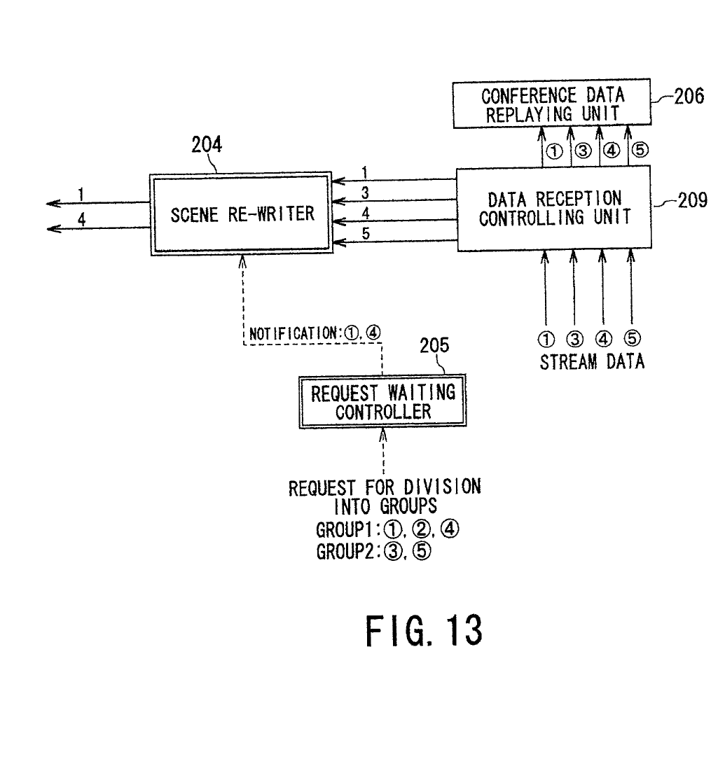

Using FIG. 13, the above operation will be detailed, in which the conference terminals participating in a multicast conference are five terminals 100-1 to 100-5. Of these, a host conference terminal to issue a request for division into groups is assigned to a terminal 100-1. As an example, the conference terminal 100-2 that receives the request will be exemplified about its operation to reflect selected stream data into scene descriptions to be re-written. This re-writing causes stream data from only the new members (conference terminals) to be replayed on the display device 211.

Practically, in a multicast conference, the conference terminal 100-2 receives stream data 1, 2, 4 and 5 from all the conference terminals participating in the conference by way of its data reception controlling unit 209. Until receiving a request for division into groups, the scene re-writer 204 reflects the stream data 1, 2, 4 and 5 received by the data reception controlling unit 209 into the scene descriptions to be re-written. As a result, the stream data 1, 2, 4 and 5 are replayed on the display device 211.

In this situation, when the host conference terminal 100-1 issues the request for division into groups, the request waiting controller 205 of the client terminal 100-2 receives this request. The controller 205 thus recognizes that, in this example, a divided group 1 is composed of three members consisting of the conference terminal 100-2 itself, the host conference terminal 100-1, and the conference terminal 1004. The request waiting controller 205 then sends to the scene re-writer 204 a notification that only the stream data 1 and 4 coming from the members' terminals 100-1 and 100-4 should be replayed.

In response to this notification, the scene re-writer 204 discards the stream data 3 and 5 without re-writing the scene descriptions. In contrast, the scene re-writer 205 chooses only the stream data 1 and 4 so that they are reflected into the scene descriptions so that they are re-written.

As a result, after the request was issued, only stream data that have experienced the re-writing at the scene re-writer 204 are replayed on the display device 211. That is, in the case of the above example, displayed are the stream data 1 and 4 coming from the terminals 1 and 4 belonging to the same group as the conference terminal 100-2. Therefore, reflecting stream data coming from only the group members into scene descriptions to re-write the descriptions makes it possible that the stream data corresponding to each divided group are solely replayed on the display device 211 in a multicast mode.

Similarly to FIGS. 8A and 8B explained in the first embodiment, the display device 211 changes its screen before and after the division into groups.

As stated above, stream data that should be replayed are selected and the selected stream data into scene descriptions are re-written. This post-processing also enables the entire group performing a multicast conference can be divided into a plurality of small groups (subgroups) in a wide range of combined group modes, with no changes in the group address that has been originally given to terminals constituting the entire group. That is, the equivalent operations and advantages to those in the first embodiment can be obtained.

Additionally, the second embodiment is able to provide another construction of the post-processing to coop with the division into groups, thus enhancing degrees of freedom in designing the conference terminal.

(Third Embodiment)

Referring to FIGS. 5, 14-17, a third embodiment of the present invention will now be described.

The third embodiment provides a further construction of a terminal that is preferably able to serve as a host's (or chairperson's) conference terminal in a multicast conference. In this embodiment, it is required for such terminal (hereafter called a host conference terminal) to have a function to issue a request for division into groups to other client conference terminals.

FIG. 5 also exemplifies the entire configuration of a multicast conferencing system according to the third embodiment. In this embodiment, the terminal 100-1 will now be detailed as a host conference terminal as follows.

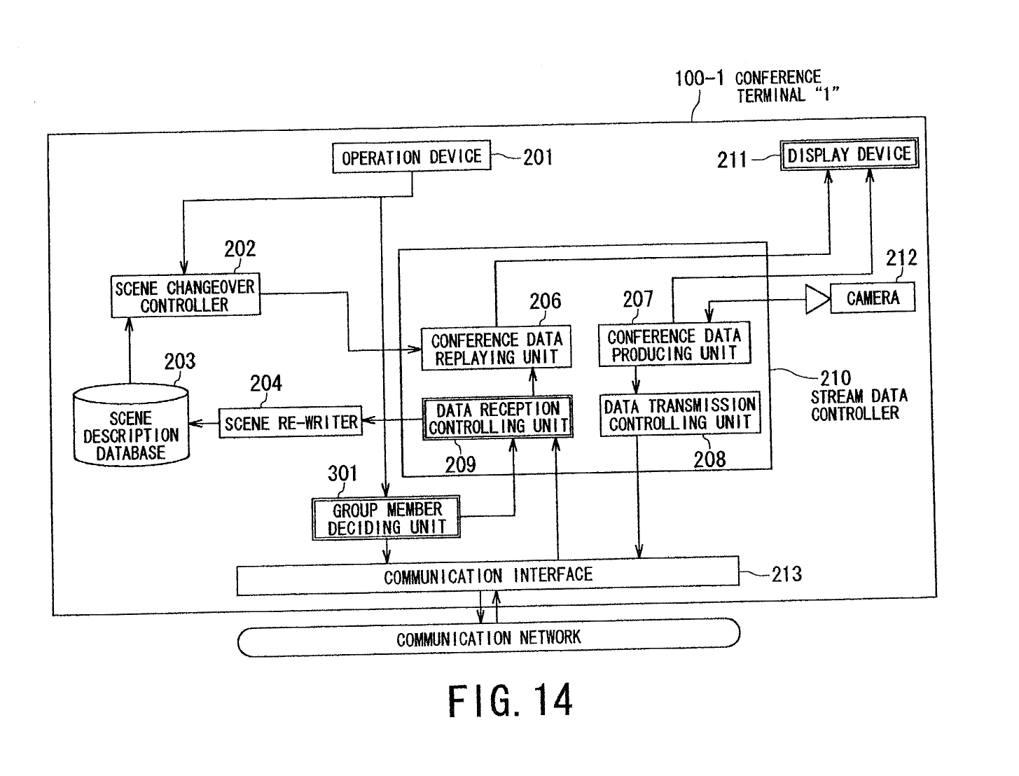

FIG. 14 details the configuration of the terminal 100-1 shown in FIG. 5. In FIG. 14, the explanation will now be concentrated on the operations of the constituents, such as a group member deciding unit 301 newly introduced instead of the foregoing request waiting controller, scene re-writer 204, and data reception controlling unit 209. The remaining constituents of the conference terminal 100-1 are almost identical to those in the first embodiment.

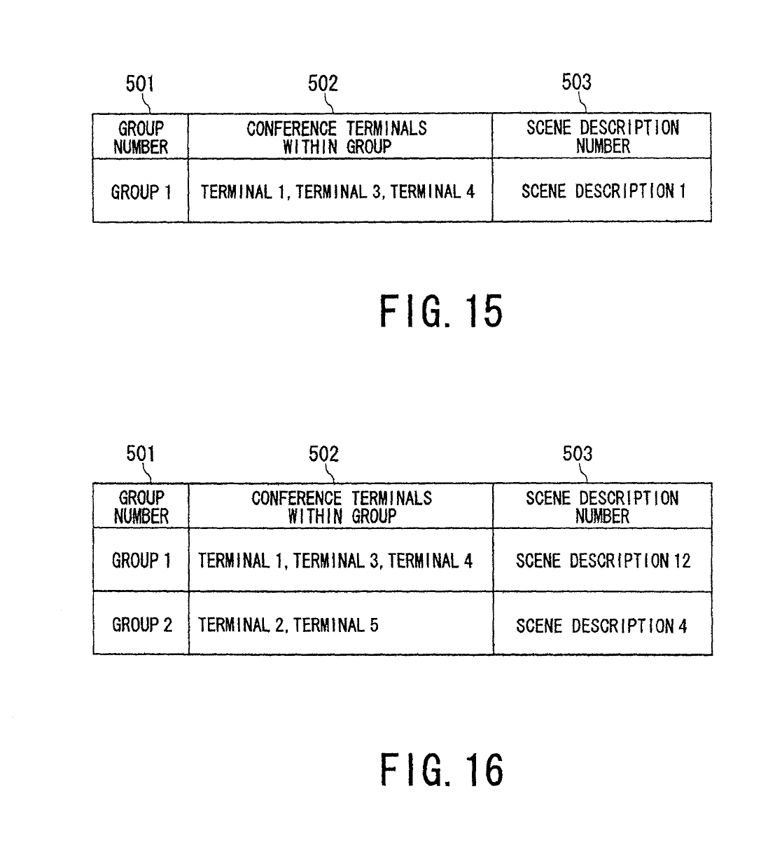

FIG. 15 exemplifies a request for division into groups, which is issued by the host conference terminal 100-1. The request in agreement with each divided group is transmitted to each terminal thereof. A reference 501 shows the numbers of the divided groups in a multicast conference, while a reference 502 shows client conference terminals (i.e., participating members in the conference) that fall into each divided group. A reference 503, which is a scene description number, specifies the numbers of the scene descriptions used by layouts for replay and display.

Alternatively, FIG. 16 exemplifies a further request for division into groups, which is transmitted from the host conference terminal 100-1 to all the terminals in a multicast mode. In this request, differently from that shown in FIG. 15, information about members belonging to all the divided groups is described, not limited to one group into which a certain terminal is grouped. Each client conference terminal received this request shown in FIG. 16 notifies its data reception controlling unit 209 of the reception of only stream data from the terminals that belongs to the same group as the client conference terminal.

Still alternatively, these notifications shown in FIGS. 15 and 16 are applied to the foregoing first and second embodiments. In the case of the second embodiment, the notification is given to the scene re-writer 204 to selectively re-write stream data.

Like the foregoing embodiments, the data reception controlling unit 209 is configured to receive stream data. The group member deciding unit 301 functionally has means for deciding groups to be divided in a multicast conference in response to a user's operation and issuing a request for division into groups toward all conference terminals that have participated in the conference. Additionally, the deciding unit 301 has means for notifying the data reception controlling unit 209 in the terminal 100-1 itself of terminals' stream data that should be selectively adopted.

The data reception controlling unit 209 responds to this notification from the group member deciding unit 301, so that the unit 209 selectively pass only stream data that have been transmitted from the conference terminals constituting the same divided group. This enables the selection and pass of stream data, group by group, for the divided groups.

Stream data selectively adopted by the data reception controlling unit 209 are reflected by the scene re-writer 204 into scene descriptions so that the descriptions are re-written, thus a scene description correspondingly to each divided group being provided.

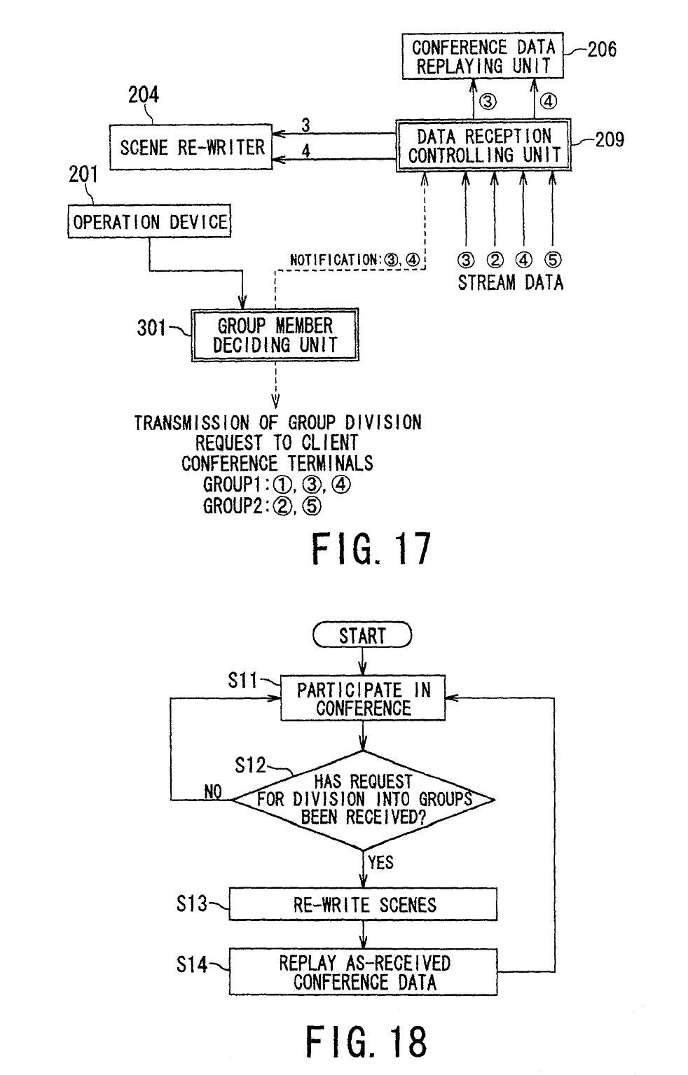

Using FIG. 17, the above operation will be detailed, in which the conference terminals participating in a multicast conference are five terminals 100-1 to 100-5. Of these, a host conference terminal that has the function of issuing a request for division into groups is assigned to a terminal 100-1. As an example, the host terminal 100-1 will be exemplified about its operation to select stream data made to pass the self terminal 100-1 so that replayed are only stream data originating from the new members of the same divided group as the terminal 100-1.

Practically, in a multicast conference, until a request for division into groups is issued, the data reception controlling unit 209 of the host conference terminal 100-1 is able to receive stream data 2 to 5 coming from all the terminals 100-2 to 100-5 participating in the conference.

When the operation device 201 receives an input from the keyboard or mouse thereof which is operated by a user of the terminal 100-1, a plurality of groups to be divided from the entire conference are decided both in number and in members. In this division, the group member deciding unit 301 issues a request for division into groups to send it to the remaining terminals 100-2 to 100-5 participating in the entire conference. In addition, the group member deciding unit 301 is able to recognize that the group 1 consists of, in members, the host conference terminal 100-1 itself and other two client conference terminals 100-3 and 100-4.

Thus the group member deciding unit 301 notifies the data reception controlling unit 209 of accepting stream data 3 and 4 transmitted from the terminals 100-3 and 100-4. The unit 209 responds to this notification so that stream data 2 and 5 coming from the terminal 100-2 and 100-5 are prohibited from being accepted at the unit 209, that is, the stream data 2 and 5 are discarded, not acceptance for them, although once received.

Only the stream data 3 and 4 are then sent from the data reception controlling unit 209 to the conference data replaying unit 206. Additionally, only the senders' identification numbers for the stream data 3 and 4 are handed over to the scene re-writer 204.

In this way, after the request for division into groups, only the stream data coming from the same group's members are allowed to pass the data reception controlling unit 209 to the conference data replaying unit 206. Hence, with no change in the group address originally given to the terminals for the entire conference, the client conference terminals can be divided into plural groups.

Similarly to FIGS. 8A and 8B explained in the first embodiment, the display device 211 changes its screen before and after the division into groups.

As stated above, the host conference terminal is able to offer the equivalent or similar advantages to those in the first embodiment. Further, the host conference terminal has the function of issuing a request for division into groups. It is therefore enough for a user to just operate the operation device 201 so as to activate the request issuing function. This remarkably improves flexibility in advancing the conference in the multicast mode.

FIG. 18 shows one modification of the third embodiment according to a multicast conferencing system of the present invention. In the third embodiment, each conference terminal 100 is explained to have, as hardware circuitry, the stream data controller 210, scene changeover controller 202, scene description database 203, scene re-writer 204, and group member deciding unit 301. However, those units 210, 202 to 204, and 301 can be replaced by a computer system, of which configuration can be made as in FIG. 10 explained before.

FIG. 18 outlines the processing performed by the CPU 253 in each client conference terminal in order to coop with a request for division into groups. In cases where the CPU 253 is under participation in a multicast conference (step S11), the CPU 253 determines at intervals whether or not it receives a request for division into groups (step S12). If this determined result is NO (such request has yet to receive), the processing is returned to step S11, while the determined result is YES (the request has been received), the CPU 253 selectively re-writes scenes (step S13). Then the CPU 253 replays conference data that has been accepted (step S14). The rewriting and replaying are carried out in such manners similar to those in the third embodiment.

Accordingly, each conference terminal that contains the computer system 250 performing a software program outlined in FIG. 18 functions identically to the constituents shown in FIG. 14.

(Fourth Embodiment)

Referring to FIGS. 5, 19 and 20, a fourth embodiment of the present invention will now be described.

The fourth embodiment provides a still further construction of a terminal that is also the host conference terminal in a multicast conference.

FIG. 5 still exemplifies the entire configuration of a multicast conferencing system according to the fourth embodiment. In this embodiment, the terminal 100-1 will now be detailed as a host conference terminal as follows.

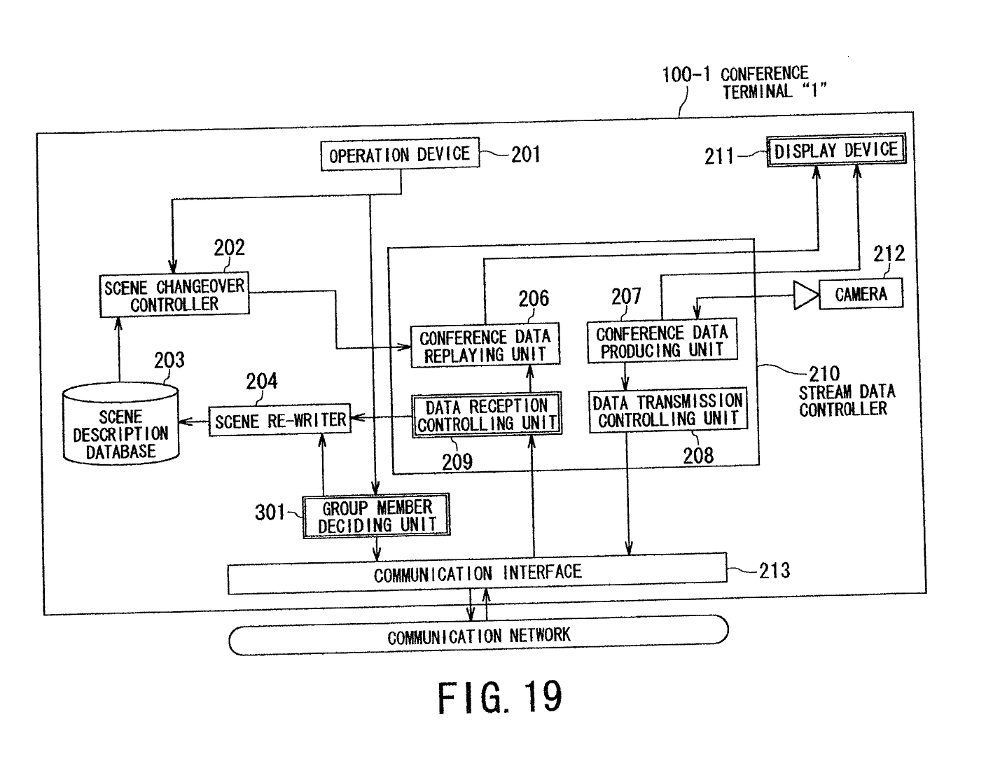

FIG. 19 details the configuration of the terminal 100-1 shown in FIG. 5. Like the third embodiment, in FIG. 9, the explanation will now be concentrated on the operations of the constituents, such as the group member deciding unit 301, scene re-writer 204, and data reception controlling unit 209. The group member deciding unit 301 has the capability of issuing a request for division into groups as well, which can be formatted in the same ways as those shown in the third embodiment (refer to FIGS. 10 and 11). The remaining constituents of the conference terminal 100-1 are almost identical to those in the first embodiment.

The data reception controlling unit 209 is configured to receive stream data coming from all the terminals that participate in a certain multicast conference. The scene re-writer 204 re-writes scene descriptions in response to the stream data the data reception controlling unit 209 has received.

The group member deciding unit 301 functionally has means for deciding groups to be divided in a multicast conference in response to a user's operation and issuing a request for division into groups toward all conference terminals that have participated in the conference. Additionally, the deciding unit 301 has means for notifying the scene re-writer 204 in the terminal 100-1 itself of particular terminals' stream data which should be selectively re-written into scene descriptions.

Responsively to the notification from the group member deciding unit 301, the scene re-writer 204 is then able to select only the stream data that have been transmitted from the terminals belonging to the same group, and reflects the selected stream data into the scene descriptions to be re-written.

As stated above, the scene descriptions are produced according to the division of a multicast conference into plural groups. Accordingly, the stream data from only the members (conference terminals) belonging to the same divided group can be replayed and displayed on the display device 211.

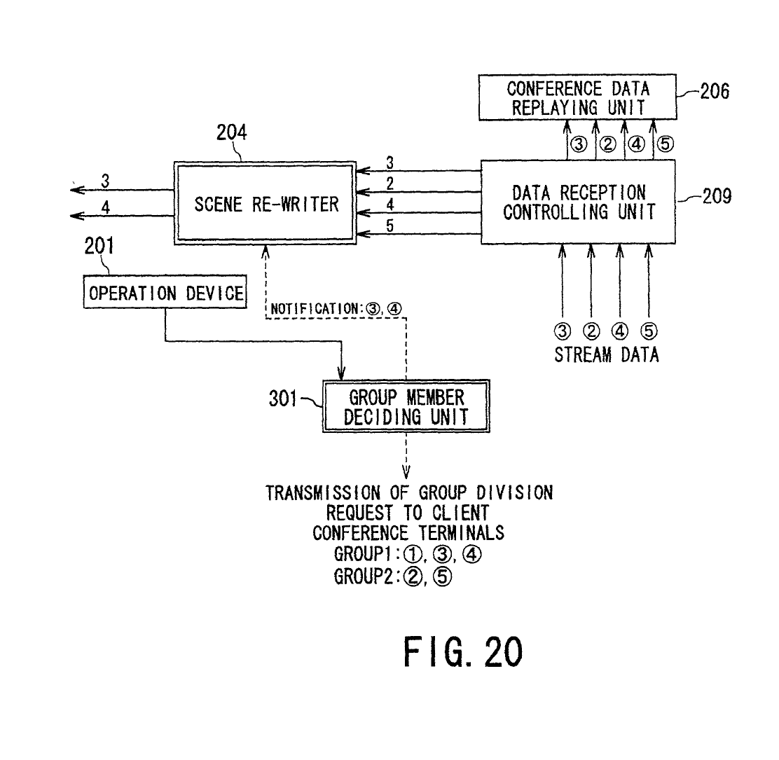

Using FIG. 20, the above operation will be detailed, in which the individual terminals are assigned in the same manner as in FIG. 13 in the second embodiment. As an example, the host conference terminal 100-1 that issues the request will be exemplified about its operation to reflect selected stream data into the scene descriptions to be re-written. This re-writing causes stream data from only the new members (terminals) to be replayed on the display device 211.

Practically, in a multicast conference, the host conference terminal 100-1 receives stream data 2 to 5 from all the client conference terminals participating in the conference, by way of its data reception controlling unit 209.

When the operation device 201 receives an input from the keyboard or mouse thereof which is operated by a user of the terminal 100-1, a plurality of groups to be divided from the entire conference are decided both in number and in members. In this division, the group member deciding unit 301 issues a request for division into groups toward the remaining terminals 100-2 to 100-5 participating in the entire conference. In addition, the group member deciding unit 301 is able to recognize that the group 1 consists of, in members, the host conference terminal 100-1 itself and other two client conference terminals 100-3 and 100-4.

The group member deciding unit 301 then sends to the scene re-writer 204 a notification that only the stream data 3 and 4 coming from the members' terminals 100-3 and 100-4 should be replayed.

In response to this notification, the scene re-writer 204 discards the stream data 2 and 5 without re-writing the scene descriptions on the stream data 2 and 5. In contrast, the scene re-writer 205 chooses only the stream data 3 and 4 so that they are reflected into the scene descriptions to be re-written.

As a result, after the request was issued, only stream data that have experienced the re-writing at the scene re-writer 204 are replayed on the display device 211. That is, in the case of the above example, displayed are the stream data 3 and 4 coming from the terminals 3 and 4 belonging to the same group as the conference terminal 100-1. Therefore, reflecting stream data coming from only the group members into scene descriptions to be re-written makes it possible that the stream data corresponding to each divided group are solely replayed on the display device 211 in a multicast mode.

Similarly to FIGS. 8A and 8B explained in the first embodiment, the display device 211 changes its screen before and after the division into groups.

As stated above, stream data that should be replayed are selected and the selected stream data are re-written into scene descriptions. This post-processing also enables the entire group performing a multicast conference can be divided into a plurality of subgroups in a wide range of subgroup modes, with no changes in the group address that has been originally given to terminals constituting the entire group. That is, the equivalent operations and advantages to those in the second and third s embodiments can be obtained.

The multicast conferencing system described above is only one example of the present invention. As an alternative system that the present invention is reduced to practice is a multicast game system. In such a multicast game system, a plurality of game terminals having the same multicast address are communicably connected to each other through a commutation network in such a manner that data involved in performing a multicast game are transmitted into the communication network in a multicast mode. In this system, according the present invention, a certain game terminal that serves as a host game terminal is able to issue toward the remaining client game terminals a request for division into groups. In response to this request, the client terminals can be divided into plural small groups to perform a multicast game on line within only the members of each group. In such division procedure, it is unnecessary to additionally issue multicast addresses to individual divided groups, thus the procedures for the division being simplified remarkably, as illustrated in FIG. 4 described before.

Further, in the foregoing embodiments, the scene description database 203 may be constructed such the scene description is stored after changing the layout of the windows.

Still further, in the foregoing embodiments, the replaying means, which is composed of the database 203, scene changeover controller 202, conference data replaying unit 206, and display device 211, may include means for selecting from the database the scene description produced responsively to the user's operation and for sending the selected scene description to other terminals.

For the sake of completeness it should be mentioned that the foregoing various embodiments are not definitive lists of possible embodiments. The expert will appreciate that it is possible to combine the various construction details or to supplement or modify them by measures known from the prior art without departing from the basic inventive principle.

What is claimed is:

1. A method of controlling processing of stream data communicated in a multicast mode, the processing being conducted by a certain terminal of a plurality of terminals having the same multicast address, the method comprising the steps of:
receiving a request for division into groups, the request indicating which one or more other terminals belong to the same group; and
performing either one of selective reception and selective replay of stream data issued from only the one or more other terminals belonging to the same group in accordance with the request, the stream data being simultaneously transmitted through a communication network to the plurality of terminals having the same multicast address.

2. The method of claim 1, wherein the performing step is a step of selectively receiving the stream data issued from only the one or more other terminals belonging to the same group.

3. The method of claim 1, wherein the performing step is a step of selectively replaying the stream data issued from only the one or more other terminals belonging to the same group.

4. A method of controlling a flow of stream data in a multicast system in which a plurality of terminals all having the same multicast address are mutually connected communicably in a multicast mode through a communication network and a certain terminal serves as a host terminal and the remaining terminals serve as client terminals, the method comprising the steps of:
making the host terminal divide the plurality of terminals to a plurality of groups of terminals in response to a division request;
making the host terminal transmit information about a plurality of divided groups to the client terminals having the same multicast address, each of the client terminals recognizing one or more terminals belonging to the same divided group; and
making each of the client terminals perform either one of selective reception and selective display of stream data issued from only the one or more terminals belonging to the same divided group, the stream data being simultaneously transmitted through the communication network to the plurality of terminals having the same multicast address.

5. A terminal distributed, together with other terminals, to form a plurality of terminals to which the same multicast address is given, through a communication network in a multicast system in which stream data are transmitted through the communication network in a multicast mode, the terminal comprising:
request receiving means for receiving a request for division into groups, the request including information indicating that the terminal belongs to which group;
producing means for producing, in response to the request, only the stream data coming from one or more other terminals belonging to the same group as the terminal; and
replaying means for replaying only the stream data produced by the producing means.

6. The terminal of claim 5, wherein the multicast system is a multicast conferencing system for a multicast conference, in which the terminal serves as one of a plurality of conference terminals.

7. The terminal of claim 6, wherein the producing means includes:
data receiving means for selectively receiving only the stream data coming from the one or more other terminals indicated by the request among the stream data coming from the other conference terminals having the same multicast address; and
scene re-writing means for re-writing the selectively received stream data into a scene description on the basis of scene descriptions making correspondence between layout information to be displayed and the stream data, and
the replaying means is configured to replay the stream data according to both of the stream data selectively received by the receiving means and the scene description re-written by the scene re-writing means.

8. The terminal of claim 6, wherein the producing means includes:
data receiving means for receiving the stream data from the other conference terminals having the same multicast address; and
scene re-writing means for selectively re-writing only the stream data into a scene description on the basis of scene descriptions making correspondence between layout information to be displayed and the stream data, the stream data to be re-written coming from the one or more other terminals indicated by the request among the stream data coming from the other conference terminals having the same multicast address, and
the replaying means is configured to selectively replay the stream data received by the receiving means in accordance with the scene description re-written by the scene re-writing means.

9. The terminal of claim 6, further comprising deciding means for arbitrarily deciding a plurality of divided groups of terminals among the plurality of terminals all having the same multicast address; and
issuing means for issuing the request, based on the plurality of groups decided, to the request receiving means and the other terminals all having the same multicast address.

10. The terminal of claim 9, wherein the producing means includes:
data receiving means for selectively receiving only the stream data coming from the one or more other terminals indicated by the request among the stream data coming from the other conference terminals having the same multicast address; and
scene re-writing means for re-writing the selectively received stream data into a scene description on the basis of scene descriptions making correspondence between layout information to be displayed and the stream data, and
the replaying means is configured to replay the stream data according to both of the stream data selectively received by the receiving means and the scene description re-written by the scene re-writing means.

11. The terminal of claim 9, wherein the producing means includes:
data receiving means for receiving the stream data from the other conference terminals having the same multicast address; and
scene re-writing means for selectively re-writing only the stream data into a scene description on the basis of scene descriptions making correspondence between layout information to be displayed and the stream data, the stream data to be re-written coming from the one or more other terminals indicated by the request among the stream data coming from the other conference terminals having the same multicast address, and
the replaying means is configured to selectively replay the stream data received by the receiving means in accordance with the scene description re-written by the scene re-writing means.

12. The terminal of claim 7, wherein the scene description consists of layout information composed of sizes and positions of windows for replaying video data included in the stream data and media information composed of information about identifying the stream data to be replayed, and
the replaying means includes scene changeover means for selectivity changing over only the layout information in response to the re-written scene description so that only the stream data coming from the one or more other terminals belonging to the same group are replayed.

13. The terminal of claim 7, wherein the scene description consists of layout information composed of sizes and positions of windows for replaying video data included in the stream data and media information composed of information about identifying the stream data to be replayed, and
the replaying means includes scene changeover means for selectivity changing over only the media information in response to the re-written scene description so that only the stream data coming from the one or more other terminals belonging to the same group are replayed.

14. The terminal of claim 13, wherein the replaying means includes means for changing a layout of the windows to be displayed by moving in position the windows responsively to a user's operation.

15. A multicast conferencing system in which a plurality of conference terminals all having the same multicast address are mutually connected communicably in a multicast mode through a communication network, the system comprising:
a single host conference terminal designated in the plurality of conference terminals, including:
first request receiving means for receiving a request for division into groups, the request including information indicating that the terminal belongs to which group;
first producing means for producing, in response to the request, only the stream data coming from one or more other terminals belonging to the same group as the terminal;
first replaying means for replaying only the stream data produced by the first producing means;
deciding means for arbitrarily deciding a plurality of divided groups of terminals among the plurality of terminals all having the same multicast address; and
issuing means for issuing the request, based on the plurality of groups decided, to the first request receiving means and client conference terminals all having the same multicast address, and
a plurality of remaining client conference terminals, each including:
second request receiving means for receiving the request for division into groups;
second producing means for producing, in response to the request, only the stream data coming from one or more other terminals belonging to the same group as the terminal; and
second replaying means for replaying only the stream data produced by the second producing means;

16. The multicast conferencing system of claim 15, wherein each of the first and second producing means includes:
data receiving means for selectively receiving only the stream data coming from the one or more other terminals indicated by the request among the stream data coming from the other conference terminals having the same multicast address; and
scene re-writing means for re-writing the selectively received stream data into a scene description on the basis of scene descriptions making correspondence between layout information to be displayed and the stream data, and
the replaying means is configured to replay the stream data according to both of the selectively received stream data and the re-written scene description.

17. The terminal of claim 15, wherein each of the first and second the producing means includes:
data receiving means for receiving the stream data from the other conference terminals having the same multicast address; and
scene re-writing means for selectively re-writing only the stream into a scene description on the basis of scene descriptions making correspondence between layout information to be displayed and the stream data, the data to be re-written coming from the one or more other terminals indicated by the request among the stream data coming from the other conference terminals having the same multicast address, and
the replaying means is configured to selectively replay the stream data received in accordance with the re-written scene description.

18. A recording medium which is readable by a computer and in which information about a method of controlling processing of stream data communicated in a multicast mode is recorded, the processing being conducted by a certain terminal of a plurality of terminals having the same multicast address, the method comprising the steps of:
receiving a request for division into groups, the request indicating which one or more other terminals belong to the same group; and
performing either one of selective reception and selective replay of stream data issued from only the one or more other terminals belonging to the same group in accordance with the request, the stream data being simultaneously transmitted through a communication network to the plurality of terminals having the same multicast address.

19. A computer-readable program for controlling processing of stream data communicated in a multicast mode, the processing being conducted by a certain terminal of a plurality of terminals having the same multicast address, the program realizing the steps of:
receiving a request for division into groups, the request indicating which one or more other terminals belong to the same group; and
performing either one of selective reception and selective replay of stream data issued from only the one or more other terminals belonging to the same group in accordance with the request, the stream data being simultaneously transmitted through a communication network to the plurality of terminals having the same multicast address.
